(19) United States
(12) Patent Application Publication
(10) Pub. No.: US 2014/0077972 A1
(43) Pub. Date: Mar. 20, 2014

(54) IDENTIFYING AND PRESENTING INFORMATION BASED ON UNIQUE VEHICLE IDENTIFIER

(71) Applicant: APPLE INC., Cupertino, CA (US)

(72) Inventors: Shailesh Rathi, San Jose, CA (US); Robert J. Walsh, Sunnyvale, CA (US)

(73) Assignee: Apple Inc., Cupertino, CA (US)

(21) Appl. No.: 13/623,562

(22) Filed: Sep. 20, 2012

(51) Int. Cl. G08G 1/00

(52) U.S. Cl. 340/902

(57) ABSTRACT

A portable electronic device can be used to present vehicle-specific information to a user. The portable electronic device can receive a message transmitted from a vehicle, the message including a unique vehicle identifier such as vehicle identification number (VIN). The portable electronic device can identify content based at least in part on the unique vehicle identifier, and present the content to the user. In some instances, the content may be presented to the user as audio output and/or visually on a display screen. Input can also be received from the user, and the portable electronic device can identify the content based in part on the received input and in part on the unique vehicle identifier.

### BACKGROUND

The present disclosure relates generally to communication between a portable electronic device and a vehicle and more particularly to using a portable electronic device to identify and present information based on a unique vehicle identifier.

There are many situations where a user may want to know information about a vehicle. For example, if the user is operating an unfamiliar vehicle, the user may want to know the location and functionality of the vehicle's user controls, a recommended fuel or oil type for the vehicle, or other information. Vehicle manufacturers often issue user manuals containing such information. Reviewing a user manual, however, can be quite time consuming, and in some instances a user manual may not be present for the user to review.

A user may also want to know information about vehicle-specific replacement parts. A replacement part for one vehicle may not be compatible with another. Consequently, replacement parts are typically assigned a number or code by the part manufacturer. To ensure that the appropriate part is purchased, the user may need to know the vehicle-specific part number. Moreover, the user may want to know the location of a nearby merchant offering the vehicle-specific replacement part for sale. The user can locate a merchant that generally sells replacement parts, but the merchant may not offer the vehicle-specific replacement part for sale or may not have the required part in stock. Alternatively, the user can take the vehicle to a mechanic to make the repair, but this can be unnecessarily time consuming and costly.

Many vehicles currently incorporate sophisticated computer systems including interfaces that support various communication standards such as Bluetooth, WiFi, 4G, and the like. Moreover, portable electronic devices (e.g., smart phones, tablet computers, media players, and the like) also currently incorporate interfaces that support such communication standards.

### SUMMARY

According to various embodiments of the present invention, a portable electronic device can be used to present vehicle-specific information to a user. The portable electronic device can include a vehicle interface configured to exchange messages with a vehicle, and a processor coupled to the vehicle interface. The portable electronic device can receive a message from the vehicle, the message containing a unique vehicle identifier. In some embodiments, the unique vehicle identifier can be a vehicle identification number (VIN) or one or more hash values corresponding to the VIN. Using the processor, the portable electronic device can identify content based at least in part on the unique vehicle identifier. The content can be stored in a memory of the portable electronic device and/or stored externally and retrieved by the portable electronic device via a network. The portable electronic device can further include a user interface coupled to the processor, and upon identification the content can be presented by the portable electronic device to a user via the user interface.

In some embodiments, the content can include a specification for the vehicle such as a fuel type, an oil type, an identifier of a replacement part, an identifier of a merchant offering the replacement part for sale, a user manual, a year, a make, a model, a color, a year, and/or other specification for the vehicle.

In some embodiments, the user interface of the portable electronic device can be configured to receive user input from the user, and the processor can be configured to identify the content based in part on the user input received from the user and in part on the unique vehicle identifier received from the vehicle.

For example, in some embodiments, the user interface of the portable electronic device can include an audio interface configured to receive audio input from the user, and the processor of the portable electronic device can be configured to identify the content based in part on the audio input and in part on the unique vehicle identifier. In some embodiments, the processor of the portable electronic device can be configured to generate audio output based on the identified content, and present the audio output to the user via the audio interface.

As another example, in some embodiments, the user interface of the portable electronic device can include a touch interface configured to receive touch input from the user, and the processor of the portable electronic device can be configured to identify the content based in part on the touch input and in part on the unique vehicle identifier. In some embodiments, the touch interface can include a display screen, and the processor of the portable electronic device can be configured to generate visual output based on the identified content, and present the visual output to the user via the display screen of the touch interface.

Embodiments of the present invention can utilize any suitable combination of user interfaces described herein to receive user input and/or to present identified content to the user.

In some embodiments, the processor of the portable electronic device can be further configured to determine a geographic location of the portable electronic device, and can identify the content based in part on the geographic location and in part on the unique vehicle identifier received from the vehicle. In some embodiments, the identification can be further based on input received from the user.

The following detailed description together with the accompanying drawings will provide a better understanding of the nature and advantages of the present invention.

### BRIEF DESCRIPTION OF THE DRAWINGS

FIG. 1 illustrates a system including a portable electronic device, a vehicle, and a network according to an embodiment of the invention.

FIG. 2 is a simplified block diagram of a system including a portable electronic device and a vehicle according to an embodiment of the present invention.

FIG. 3 is a flow diagram of a process usable by a portable electronic device to identify content based on a unique vehicle identifier according to an embodiment of the present invention.

FIG. 4 is a flow diagram of a process usable by a portable electronic device to identify content based on a unique vehicle identifier and user input according to an embodiment of the present invention.

FIG. 5 is a flow diagram of a process usable by a portable electronic device to identify content based on a unique vehicle identifier, user input, and a geographic location of the device according to an embodiment of the present invention.

### DETAILED DESCRIPTION

According to various embodiments of the present invention, a portable electronic device can be used to present vehicle-specific information to a user. For example, the portable electronic device can receive a message from a vehicle, the message containing a unique vehicle identifier such as a VIN. The portable electronic device can identify content based at least in part on the unique vehicle identifier. The content can be stored in a memory of the portable electronic device. In some embodiments, at least a portion of the content can be stored externally (e.g., on a web-based server computer) and retrieved by the portable electronic device via a wireless network. The identified content can include, for example, one or more specifications for the vehicle such as a user manual, year, make, model, color, fuel type, oil type, replacement part numbers, locations to purchase replacement parts, and other specifications for the vehicle. Upon identification, the content including the vehicle specifications can be presented to the user via a user interface of the portable electronic device (e.g., a speaker, display screen, or the like). The portable electronic device can also receive user input (e.g., spoken audio input from the user, touch input, or the like), and can identify the content based in part on the user input and in part on the unique vehicle identifier received from the vehicle. The portable electronic device can further identify the content based on the geographic location of the device.

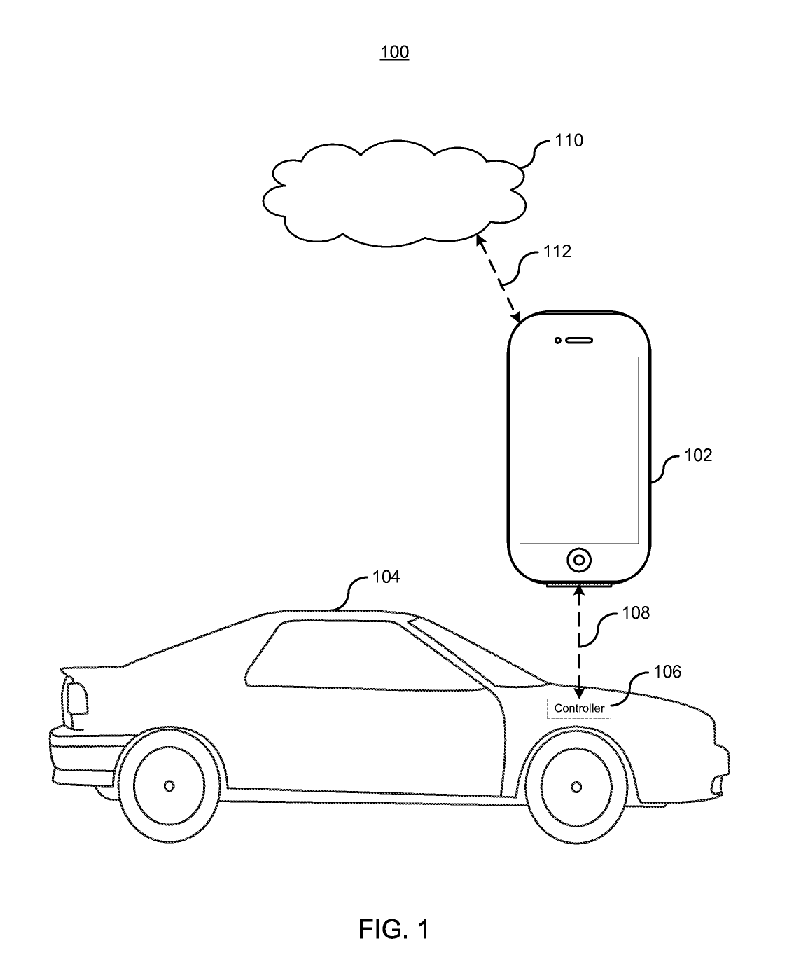

FIG. 1 illustrates a system 100 including a portable electronic device 102, a vehicle 104, and an external data source 110.

Portable electronic device 102 can be, for example, a media player, a smart phone, a personal digital assistant, a tablet computer, a laptop computer, or any other electronic device that is portable (e.g., easily carried by a user from place to place) and capable of communicating with other devices.

Vehicle 104 can be any suitable transportation machinery, such as an automobile, a truck, a bus, a tractor, a golf cart, a go-kart, a motorcycle, a scooter, a bicycle, a motorized bicycle, a boat, a watercraft (e.g., a jet-ski), an aircraft, a lawn mower, a snowmobile, a remote controlled device (e.g., a remote controlled car or airplane), or the like.

As described herein, portable electronic device 102 can receive a message from vehicle 104, the message including a unique vehicle identifier for the vehicle. For example, the unique vehicle identifier can be a VIN or one or more hash values corresponding to the VIN. A VIN is typically a unique serial number used by various vehicle industries to identify individual vehicles. The VIN can be assigned at the time of manufacturing, and can be determined by any suitable standard such as FMVSS 115, ISO 3779, SAE J853, ADR 61/2, or the like. Further, the VIN can include 17 alpha-numeric characters, for example, that correspond to various specifications for the vehicle such as the manufacturer, the model year, the manufacturing plant, and attributes of the vehicle such as make, model, color, and/or the like. In some embodiments, the unique vehicle identifier transmitted by vehicle 104 to portable electronic device 102 can be any data that corresponds to one or more specifications for vehicle 104.

As shown in FIG. 1, vehicle 104 can include a controller 106 configured to transmit a message containing the unique vehicle identifier (and/or other information) to portable electronic device 102 via a connection 108. In some embodiments, connection 108 can be a wireless connection, and messages can be exchanged using any suitable wireless protocol. For example, connection 108 can be a short range wireless network, and portable electronic device 102 can exchange messages with vehicle 104 using Bluetooth, Bluetooth LE, or any other suitable short range wireless protocol. In another example, connection 108 can be an advanced data network, and portable electronic device 102 can exchange messages with vehicle 104 using 3G, 4G, EDGE, WiFi (e.g., the IEEE 802.11 family of standards), or any other suitable wireless data protocol.

In some embodiments, portable electronic device 102 can include a receptacle connector (not shown) for connecting to a connector (not shown) of vehicle 104. For example, the receptacle connector of portable electronic device 102 and the connector of vehicle 104 can include a plurality of pins that can carry electrical signals (e.g., messages). The receptacle connector and the connector can be designed to mate with each other to physically and electrically couple the contacts of the receptacle connector with the connector so that messages can be exchanged between vehicle 104 and portable electronic device 102. In some embodiments, connection 108 as shown in FIG. 1 can include a cable. The cable can include a connector and a receptacle connector designed to mate with the receptacle connector of portable electronic device 102 and the connector of vehicle 104, respectively, thus allowing messages to be exchanged. For example, vehicle 104 can transmit a message containing a unique vehicle identifier to portable electronic device 102 via the cable.

Upon receipt of a message containing the unique vehicle identifier from vehicle 104 via connection 108, portable electronic device 102 can identify content based at least in part on the received unique vehicle identifier. In some embodiments, the identified content can be stored in a memory of portable electronic device 102. The identified content can also be retrieved from external data source 110 via a wireless connection 112 in some embodiments. For example, external data source 110 can include a web-based server computer, and wireless connection 112 can include an advanced wireless data network supporting communication protocols such as 3G, 4G, EDGE, WiFi (e.g., the IEEE 802.11 family of standards), or any other suitable wireless data protocol. In embodiments of the invention, the identified content can be in part stored in the memory of portable electronic device 102 and in part retrieved from external data source 110.

In some embodiments, the identified content can include a specification for vehicle 104. For example, the specification can include one or more of a fuel type, an oil type, an identifier of a replacement part, an identifier of a merchant offering the replacement part for sale, a user manual, a year, a make, a model, a color, a year of manufacture, and/or any other information associated with vehicle 104.

Once the content is identified based on the unique vehicle identifier, portable electronic device 102 can present the content to the user via a user interface.

It will be appreciated that the portable electronic device and the vehicle of FIG. 1 are illustrative and that variations and modifications are possible. A portable electronic device and/or a vehicle can implement any combination of functionality. In some embodiments, rather than receiving a message from the vehicle containing the unique vehicle identifier, the portable electronic device can directly access various modules and/or storage media of the vehicle to retrieve the unique vehicle identifier.

Messages can be exchanged between the portable electronic device and the vehicle using various formats and signaling techniques, with details depending on the protocol utilized. Examples of suitable formats and processes are described below.

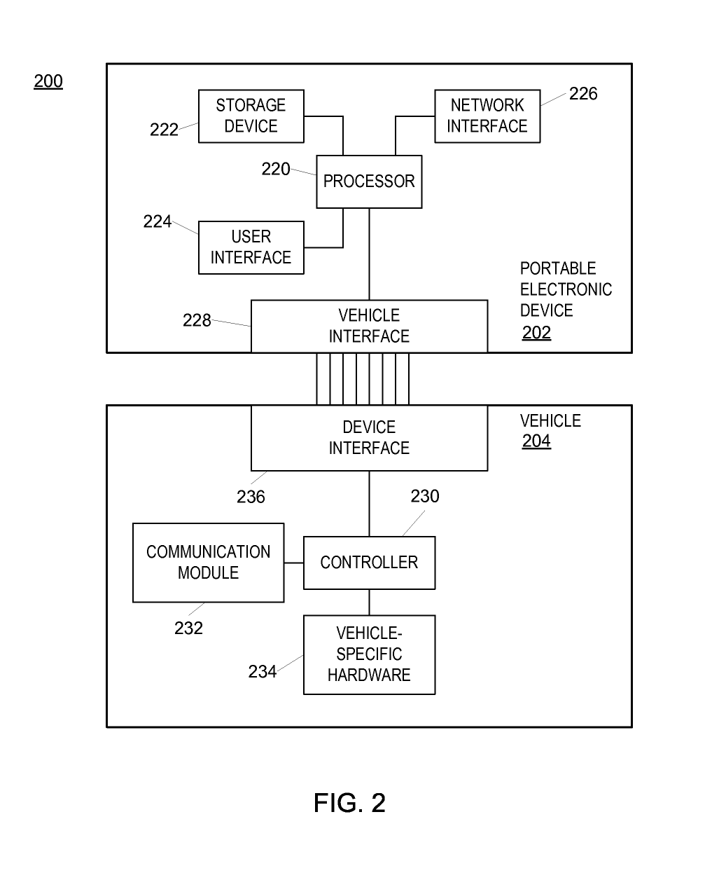

A portable electronic device and a vehicle can be implemented as separate computing devices that communicate via one or more interfaces to support interoperation. FIG. 2 is a simplified block diagram of a system 200 including a portable electronic device 202 and a vehicle 204 according to an embodiment of the present invention. In this embodiment, portable electronic device 202 (e.g., implementing portable electronic device 102 of FIG. 1) can provide computing, communication, media playback, and/or other capabilities. Portable electronic device 202 can include a processor 220, a storage device, 222, a user interface 224, a network interface 226, and a vehicle interface 228. Portable electronic device 202 can also include other components (not explicitly shown) such as a battery, power controllers, and other components operable to provide various enhanced capabilities.

Storage device 222 can be implemented using disk, flash memory, or any other non-transitory storage medium, or a combination of media, and can include volatile and/or non-volatile media. In some embodiments, storage device 222 can store data objects such as audio files, video files, image or artwork files, information about a user's contacts (names, addresses, phone numbers, etc.), information about a user's scheduled appointments and events, notes, and/or other types of information. Storage device 222 can also store data objects such as specifications for vehicle 204 as described herein. In some embodiments, storage device 222 can also store one or more application programs to be executed by processor 220 (e.g., video game programs, personal information management programs, media playback programs, etc.).

User interface 224 can include input devices such as a touch pad, touch screen, scroll wheel, click wheel, dial, button, switch, keypad, microphone, and/or the like, as well as output devices such as a display screen, indicator lights, speakers, headphone jacks, or the like, together with supporting electronics (e.g., digital-to-analog or analog-to-digital converters, signal processor, and/or the like). A user can operate input devices of user interface 224 to invoke the functionality of portable electronic device 202 and can view and/or hear output from portable electronic device 202 via output devices of user interface 224.

In some embodiments, user interface 224 can include a microphone including one or more acoustic-to-electric transducers or sensors configured to convert sounds into an electrical signal. For example, the microphone can be a condenser microphone, an electret condenser microphone, a dynamic microphone, a ribbon microphone, a carbon microphone, a piezoelectric microphone, a fiber optic microphone, a laser microphone, a liquid microphone, a MEMS microphone, and/or the like. In embodiments of the present invention, the microphone can receive audio (e.g., voice) input from a user and transmit the voice input to processor 220 in the form of an electrical signal.

In some embodiments, user interface 224 can include a speaker including one or more electroacoustic transducers configured to produce sound in response to an electrical audio signal. For example, the speaker can be a full-range driver, a subwoofer, a woofer, a mid-range driver, a tweeter, a coaxial driver, and/or the like. In embodiments of the present invention, the speaker can receive audio output generated by processor 220, and present the audio output to a user.

Processor 220 can include, for example, one or more integrated circuits such as single-core or multi-core microprocessors and/or microcontrollers executing program code to perform various functions and operations associated with portable electronic device 202. In operation, processor 220 can control the operation of portable electronic device 202. In various embodiments, processor 220 can execute a variety of programs in response to program code and can maintain multiple concurrently executing programs or processes. At any given time, some or all of the program code to be executed can be resident in processor 220 and/or in storage media such as storage device 222.

Through suitable programming, processor 220 can provide various functionality for portable electronic device 202. For example, in some embodiments, processor 220 can receive a message from vehicle interface 228, the message containing a unique vehicle identifier. Processor 220 can identify content based at least in part on the unique vehicle identifier, and present the content to a user via user interface 224. Processor 220 can also be configured to receive user input (e.g., audio input, touch input, and/or the like) from user interface 224, and can be configured to determine a geographic location of portable electronic device 202. As such, process 220 can be configured to identify content based on the unique vehicle identifier and any suitable combination of audio input, touch input, geographic location, etc. Processor 220 may also be configured to generate output (e.g., audio output, visual output, and/or the like) based on the identified content, and to transmit the output to user interface 224 for presentment to a user. Processor 220 can also execute other programs to control other functions of portable electronic device 202, including application programs that may be stored in storage device 222.

Network interface 226 can provide voice and/or data communication capability for portable electronic device 202. In some embodiments, network interface 226 can include radio frequency (RF) transceiver components for accessing wireless voice and/or data networks (e.g., using cellular telephone technology, advanced data network technology such as 3G, EDGE or 4G, WiFi (IEEE 802.11 family standards), or other mobile communication technologies (or any combination thereof), components for short-range wireless networking (e.g., using Bluetooth standards), GPS receiver components, and/or other components. In embodiments of the present invention, portable electronic device 202 can utilize network interface 226 to identify and retrieve content stored external to portable electronic device 202 (e.g., from external data source 110 of FIG. 1). In some embodiments, network interface 226 can provide wired network connectivity (e.g., Ethernet) in addition to or instead of a wireless interface. Network interface 226 can be implemented using a combination of hardware (e.g., driver circuits, antennas, modulators/demodulators, encoders/decoders, and other analog and/or digital signal processing circuits) and software components.

Vehicle interface 228 can allow portable electronic device 202 to communicate with vehicle 204. In some embodiments, vehicle interface 228 can include a connector such as those used in various iPod®, iPhone®, and iPad® products, as well as the supporting circuitry. The connector can provide connections for power and ground as well as for one or more data communication interfaces such as Universal Serial Bus (USB), FireWire (IEEE 1394 standard), and/or universal asynchronous receiver/transmitter (UART). The connector can provide dedicated power and ground contacts, as well as some number (e.g., four) of programmable digital data contacts that can be used to implement different communication technologies in parallel. For example, two pins can be assigned as USB data pins (D+ and D−) and two other pins can be assigned as serial transmit/receive pins (e.g., implementing a UART interface). The assignment of pins to particular communication technologies can be negotiated while the connection is being established. In embodiments of the present invention, the connector can also provide connections for audio and/or video signals, which may be transmitted to or from portable electronic device 202 in analog and/or digital formats. Thus, vehicle interface 228 can support multiple communication channels, and a given vehicle can use any or all of these channels. In some embodiments of the present invention, vehicle interface 228 can support wireless communication (e.g., via WiFi, Bluetooth, or other wireless protocols) with vehicle 204 in addition to or instead of wired communication channels.

In some embodiments, portable electronic device 202 can include location determining circuitry (not explicitly shown) such as any suitable hardware and/or software for determining a geographic location of portable electronic device 202. It will be appreciated that portable electronic device 202 can determine a geographic location by any suitable technique, such as by utilizing a Global Positioning System (GPS), cellular tower triangulation data, cellular tower signal strength data, wireless access point data, an Internet Protocol (IP) address, and/or the like.

Portable electronic device 202 can also include voice recognition circuitry (not explicitly shown) such as any suitable hardware and/or software for facilitating a voice recognition mode of portable electronic device 202. A voice recognition mode can include any operational mode of portable electronic device 202 wherein audio input (e.g., a word, phrase, or sound spoken by a user), as distinguished from touch input, can be used to provide a user access to the various services, applications, stored data, and/or functionalities of portable electronic device 202.

Vehicle 204 (e.g., implementing vehicle 104 of FIG. 1) can include controller 230, communication module 232, and vehicle-specific hardware 234.

Controller 230 can include, for example, one or more integrated circuits such as single-core or multi-core microprocessors and/or microcontrollers executing program code to perform various functions associated with vehicle 204. For example, controller 230 can transmit a message to portable electronic device 202, the message containing a unique vehicle identifier. Where vehicle 204 incorporates a user-operable control, controller 230 can interpret user operation of the control and responsively invoke functionality of vehicle 204. In some instances, the invoked functionality can include sending message to and/or receiving message from portable electronic device 202.

Communication module 232 can facilitate the communication between controller 230 of vehicle 204 and processor 220 of portable electronic device 202. In some embodiments, communication module 232 can include radio frequency (RF) transceiver components for wirelessly exchanging messages with portable electronic device 202 via a data network (e.g., using cellular telephone technology, advanced data network technology such as 3G, EDGE or 4G, WiFi (IEEE 802.11 family standards), or other mobile communication technologies (or any combination thereof), components for short-range wireless networking (e.g., using Bluetooth standards), GPS receiver components, and/or other components. In embodiments of the present invention, communication module 232 can facilitate wired communication with portable electronic device 202. Communication module 232 can be implemented using a combination of hardware (e.g., driver circuits, antennas, modulators/demodulators, encoders/decoders, and other analog and/or digital signal processing circuits) and software components.

Vehicle-specific hardware 234 can include any other components that may be present in vehicle 204 to enable its functionality. For example, in embodiments of the present invention, vehicle-specific hardware 234 can include one or more storage devices using fixed or removable storage media, a GPS receiver, a power supply and/or power management circuitry, environmental sensors (e.g., temperature sensor, pressure sensor, accelerometer, chemical sensor, etc.), and/or the like. It is to be understood that any type of vehicle functionality can be supported by providing appropriate vehicle-specific hardware 234.

Device interface 236 can cooperate with communication module 232 to allow vehicle 204 to communicate with portable electronic device 202. In embodiments of the present invention, device interface 236 can include a connector that mates directly with a connector included in portable electronic device 202, such as those used in various iPod®, iPhone®, and iPad® products. Such a connector can be used to supply power to portable electronic device 202 and/or receive power from portable electronic device 202, to send and/or receive audio and/or video signals in analog and/or digital formats, and to communicate information using one or more data communication interfaces such as USB, UART, and/or FireWire. Other connectors may also be used; for example, device interface 236 can incorporate a standard USB connector and can connect to vehicle interface 228 of portable electronic device 202 via an adapter cable. In other embodiments of the present invention, device interface 236 can support wireless communication (e.g., WiFi, Bluetooth, or other wireless protocols) in addition to or instead of wired communication channels.

It will be appreciated that the system configurations and components described herein are illustrative and that variations and modifications are possible. Portable electronic device 202 and/or vehicle 204 may have other capabilities not specifically described herein.

Connectors at the respective interfaces 228, 236 of portable electronic device 202 and vehicle 204 can be complementary or not as desired. Where two connectors are not complementary, an adapter (not shown) can be provided to connect the two devices. While connectors may be described herein as having pins, a term generally associated with conventional electronic devices having wires to connect components, it is to be understood that other signal paths (e.g., optical signaling) can be substituted. Further, in some embodiments, some or all of the connections can be wireless, and connectors can be omitted where wireless interfaces are provided.

Further, while portable electronic device 202 and vehicle 204 are described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Vehicle interface 228 of portable electronic device 202 and device interface 236 of vehicle 204 allow portable electronic device 202 to be connected with vehicle 204 and subsequently disconnected from vehicle 204. As used herein, portable electronic device 202 and vehicle 204 are “connected” whenever a communication channel is established between their respective interfaces and “disconnected” when the channel is terminated. Such connection can be achieved via direct physical connection (e.g., with mating connectors), indirect physical connection (e.g., via a cable), and/or wireless connection (e.g., via Bluetooth or other suitable wireless protocol).

In some embodiments, portable electronic device 202 and vehicle 204 can communicate while connected by exchanging messages and data according to an “accessory protocol.” The messages and data can be communicated, for example, using any wired or wireless transport medium provided by the relevant interfaces.

The accessory protocol can define a “universe” of messages that can be exchanged between portable electronic device 202 and any accessories connected thereto, such as vehicle 204. The message format can include, e.g., a start bit or bit sequence to indicate that what follows is a message code, followed by an actual message code that can be interpreted and acted on by the recipient. At least some of the message codes may have one or more associated parameters defined by the protocol, and a message can include values for any such parameters in addition to the message code. In some instances, the protocol can further specify a behavior for a recipient in the event that a particular parameter associated with a message code is not received or in the event that an unexpected parameter is received with a message code. The number of parameters can be different for different messages, and in some instances, a parameter may have variable length. In some embodiments, the message codes can be defined such that a given message code is valid in only one direction. Other message structures can also be used.

The accessory protocol can also define a format for the exchange of messages. For instance, the accessory protocol may specify that a message is sent using one or more packets, each of which has a header and a payload. The header provides basic information (e.g., a start indicator, length of the packet, packet sequence number, identifier of a session with which the packet is associated, and/or other information), while the payload provides all or part of the message data. The packet can also include error-detection or error-correction codes as known in the art.

In some embodiments, the messages can be logically grouped into a “general” message set and an “optional” message set. Every accessory and every portable electronic device that use the accessory protocol can be required to support at least the general message set. This message set can include messages enabling portable electronic device 202 and vehicle 204 to identify and authenticate themselves to each other and to provide information about their respective capabilities, including which (if any) of the messages in the optional set each supports. For example, the general message set can include a message vehicle 204 can send to portable electronic device 202 to list every message in the optional set that vehicle 204 is capable of sending and every message in the optional set that vehicle 204 is capable of receiving and acting on. The general message set can also include authentication messages that portable electronic device 202 can use to verify the purported identity and capabilities of vehicle 204 (or vice versa), and vehicle 204 (or portable electronic device 202) may be blocked from invoking certain (or all) of the optional messages if the authentication is unsuccessful.

The optional message set can include messages related to various functionalities that might or might not be supported in a given accessory. For example, the optional message set can include simple remote messages that allow vehicle 204 to identify a function of portable electronic device 202 to be invoked, remote user interface messages that can be used to obtain information related to replicating all or part of a user interface of portable electronic device 202 on vehicle 204 (thereby supporting a more advanced remote control), messages that allow a user to control a radio tuner in vehicle 204 by operating portable electronic device 202 and/or to control a radio tuner in portable electronic device 202 by operating vehicle 204, messages that facilitate the transfer of data objects between portable electronic device 202 and vehicle 204 (e.g., the transfer of a unique vehicle identifier from vehicle 204 to portable electronic device 202), and so on. Any combination of optional messages can be defined in an accessory protocol, and there is no requirement that a given accessory or portable electronic device support all (or even any) of the optional messages.

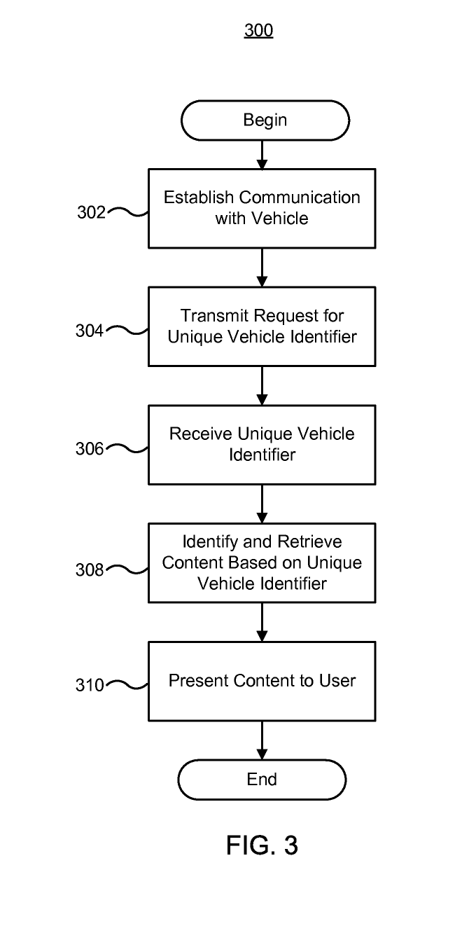

FIG. 3 is a flow diagram of a process 300 usable by a portable electronic device (e.g., portable electronic device 102 of FIG. 1 or portable electronic device 202 of FIG. 2) to identify content based on a unique vehicle identifier according to an embodiment of the present invention.

At block 302, the portable electronic device can establish communication with the vehicle. For example, the portable electronic device can detect a connection to the vehicle based on a voltage detected at the connector. The vehicle can also request a connection via a wireless protocol (e.g., Bluetooth, WiFi, and/or the like), and the portable electronic device can respond to establish a connection usable to exchange messages.

Upon detecting a connection, the portable electronic device can communicate with the vehicle to perform a number of authentication steps by exchanging messages (e.g., utilizing vehicle interface 228 and device interface 236 of FIG. 2). For example, the vehicle can transmit one or more messages to the portable electronic device to identify and authenticate the vehicle, and/or the portable electronic device can transmit one or more messages to the vehicle to identify and authenticate the portable electronic device. Messages exchanged at block 302 can also relate to the respective capabilities of the vehicle and the portable electronic device. For example, the portable electronic device can transmit a message to the vehicle indicating that the portable electronic device is configured to accept and act on a received message containing a unique vehicle identifier. Similarly, the vehicle can transmit a message to the portable electronic device indicating that the vehicle is configured to generate and transmit a message containing the unique vehicle identifier. Communication between the portable electronic device and the vehicle can be established upon completion of the exchange of messages relating to the capabilities and authentication. In some embodiments of the present invention, the portable electronic device can provide a user with a notification that communication with the vehicle is established by, for example, providing audio output at a speaker and/or visual output on a display screen of the portable electronic device.

At block 304, after communication between the portable electronic device and the vehicle is established, the portable electronic device can transmit a message to the vehicle, the message containing a request for a unique vehicle identifier. At block 306, the vehicle can generate and transmit a message to the portable electronic device, the message containing the requested unique vehicle identifier. For example, the message transmitted by the vehicle can contain a VIN for the vehicle, or one or more hash values corresponding to the VIN.

Once the unique vehicle identifier is received, at block 308, the portable electronic device can identify and retrieve content based at least in part on the unique vehicle identifier. In some embodiments, the portable electronic device can use the unique vehicle identifier to identify and retrieve content stored in a memory (e.g., storage device 222 of FIG. 2) of the portable electronic device. For example, the memory can store various specifications (e.g., a user manual, year, make, model, color, etc.) for the vehicle as previously downloaded by the user from an Internet website associated with the vehicle's manufacturer and/or from any other suitable external data source. In some embodiments of the present invention, upon establishing communication with the vehicle, the portable electronic device can determine if such content has been downloaded and stored in the memory. If it is determined that the content is not present in the memory, the portable electronic device can prompt the user to perform the download. The stored content can be linked to the unique vehicle identifier, and in some embodiments of the invention, the portable electronic device can store specifications for a plurality of the user's vehicles, each linked to the appropriate unique vehicle identifier.

In some embodiments of the present invention, at block 308, the portable electronic device can identify and retrieve the content from an external data source (e.g., external data source 110 of FIG. 1). For example, in lieu of or in addition to storing the content in a memory, the portable electronic device can retrieve the content from an external database associated with the vehicle manufacturer (e.g., a website) or any other suitable external data source.

At block 310, the portable electronic device can present the identified content to the user via a user interface. For example, the portable electronic device can generate visual output based on the identified content, and present the visual output to the user via a display screen of the portable electronic device. In some embodiments, the visual output can include an image of the vehicle, a video of the vehicle, descriptions of various specifications for the vehicle, and other vehicle-specific content. The visual output may also include operating instructions for various vehicle features such as an audio/video interface, a global positioning system, seat adjustments, mirror adjustments, climate control, and/or the like.

In some embodiments of the present invention, upon presenting the identified content to the user, the portable electronic device can be configured to receive user input relating to the identified content. For example, the portable electronic device can receive audio input from the user (e.g., at a microphone), the audio input requesting additional information relating to the identified content such as further details, additional specifications, and/or other information. In some embodiments, the portable electronic device can include a display screen that includes a touch interface. For example, the portable electronic device can provide the user with one or more user-selectable controls (e.g., a graphical menu, drop-down, etc.) on the display screen, and in response to receiving touch input from the user, the portable electronic device can identify, retrieve, and present additional information relating to the identified content at the display screen as visual output and/or at a speaker as audio output.

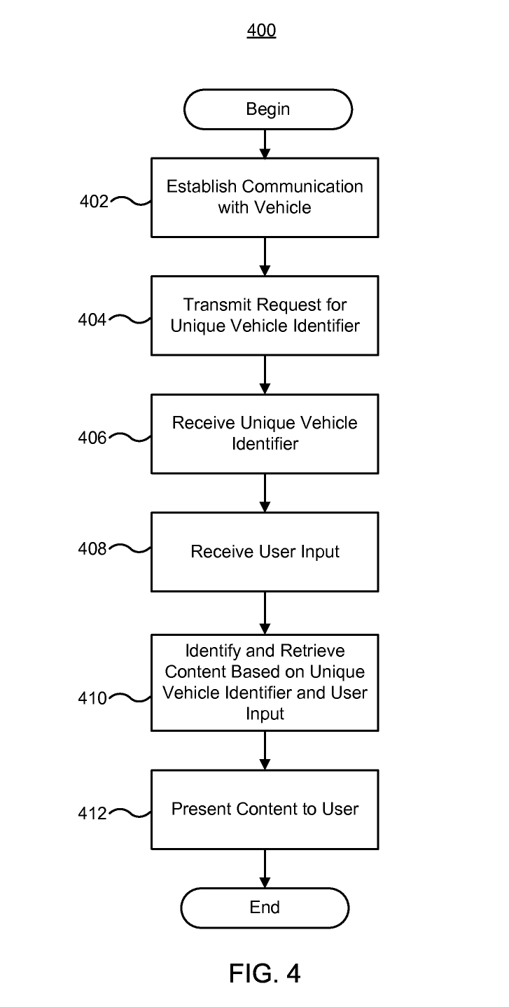

FIG. 4 is a flow diagram of a process 400 usable by a portable electronic device (e.g., portable electronic device 102 of FIG. 1 or portable electronic device 202 of FIG. 2) to identify content based on a unique vehicle identifier and user input according to an embodiment of the present invention.

At block 402, the portable electronic device can establish communication with the vehicle. For example, the portable electronic device can detect a connection to the vehicle based on a voltage detected at the connector. The vehicle can also request a connection via a wireless protocol (e.g., Bluetooth, WiFi, and/or the like), and the portable electronic device can respond to establish a connection usable to exchange messages.

Upon detecting a connection, the portable electronic device can communicate with the vehicle to perform a number of authentication steps by exchanging messages (e.g., utilizing vehicle interface 228 and device interface 236 of FIG. 2). For example, the vehicle can transmit one or more messages to the portable electronic device to identify and authenticate the vehicle, and/or the portable electronic device can transmit one or more messages to the vehicle to identify and authenticate the portable electronic device. Messages exchanged at block 402 can also relate to the respective capabilities of the vehicle and the portable electronic device. For example, the portable electronic device can transmit a message to the vehicle indicating that the portable electronic device is configured to accept and act on a received message containing a unique vehicle identifier. Similarly, the vehicle can transmit a message to the portable electronic device indicating that the vehicle is configured to generate and transmit a message containing the unique vehicle identifier. Communication between the portable electronic device and the vehicle can be established upon completion of the exchange of messages relating to the capabilities and authentication. In some embodiments of the present invention, the portable electronic device can provide a user with a notification that communication with the vehicle is established by, for example, providing audio output at a speaker and/or visual output on a display screen of the portable electronic device.

At block 404, after communication between the portable electronic device and the vehicle is established, the portable electronic device can transmit a message to the vehicle, the message containing a request for a unique vehicle identifier. At block 406, the vehicle can generate and transmit a message to the portable electronic device, the message containing the requested unique vehicle identifier. For example, the message can contain a VIN for the vehicle, or one or more has values corresponding to the VIN.

At block 408, user input can be received at a user interface of the portable electronic device. For example, in an embodiment of the invention, the user interface can include an audio interface including a microphone, and the user can provide input in the form of audio (e.g., spoken) input. In some embodiments, the user interface can include a touch interface (e.g., a touch screen and/or control buttons), and the user can provide input to the portable electronic device in the form of touch input.

Once the unique vehicle identifier and the user input are received, at block 410, the portable electronic device can identify content based in part on the unique vehicle identifier and in part on the received user input. In some embodiments, the portable electronic device can use the unique vehicle identifier and/or the received user input to identify and retrieve content stored in a memory (e.g., storage device 222 of FIG. 2) of the portable electronic device. For example, the memory can store various specifications (e.g., replacement part identifiers, a user manual, year, make, model, color, etc.) for the vehicle as previously downloaded by the user from an Internet website associated with the vehicle's manufacturer and/or from any other suitable external data source. In some embodiments of the present invention, upon establishing communication with the vehicle, the portable electronic device can determine if such content has been downloaded and stored in the memory. If it is determined that the content is not present in the memory, the portable electronic device can prompt the user to perform the download. The stored content can be linked to the unique vehicle identifier, and in embodiments of the invention, the portable electronic device can store specifications for a plurality of the user's vehicles, each linked to the appropriate unique vehicle identifier.

In some embodiments of the present invention, at block 410, the portable electronic device can identify and retrieve the content from an external data source (e.g., external data source 110 of FIG. 1). For example, in lieu of or in addition to storing the content in a memory, the portable electronic device can retrieve the content from an external database associated with the vehicle manufacture (e.g., a website) or any other suitable external data source.

At block 412, the portable electronic device can present the identified content to the user via the user interface. For example, the portable electronic device can present visual output to the user via a display screen of the portable electronic device. As another example, the audio interface of the portable electronic device can include a speaker configured to present audio output to the user. As such, the portable electronic device can generate visual output and/or audio output based on the identified content, and can present the output to the user via the user interface.

To illustrate process 400, after receiving the unique vehicle identifier from the vehicle, at block 408, the portable electronic device can receive user input (e.g., audio and/or touch input) involving a request for the recommended fuel type for the vehicle. At block 410, the portable electronic device can use the unique vehicle identifier to retrieve one or more specifications (e.g., a digital version of the vehicle's user manual) stored in a memory of the device and/or stored externally and accessible via a data network, for example. Once the one or more specifications are retrieved, the portable electronic device can identify the recommended fuel type for the vehicle. At block 412, the recommended fuel type can be presented to the user via the user interface (e.g., as audio output at a speaker and/or as visual output on a display screen of the portable electronic device).

Depending on the nature of the request included in the received user input, at block 412, the portable electronic device can identify and present content including any suitable specification for the vehicle as described herein, such as a required oil type, replacement part identifiers, instructions for replacing a part, information regarding the location and functionality of the vehicle's user controls, and/or other specifications.

In some embodiments of the present invention, the portable electronic device can be further configured to determine a geographic location of the device, and content can be identified based in part upon the geographic location.

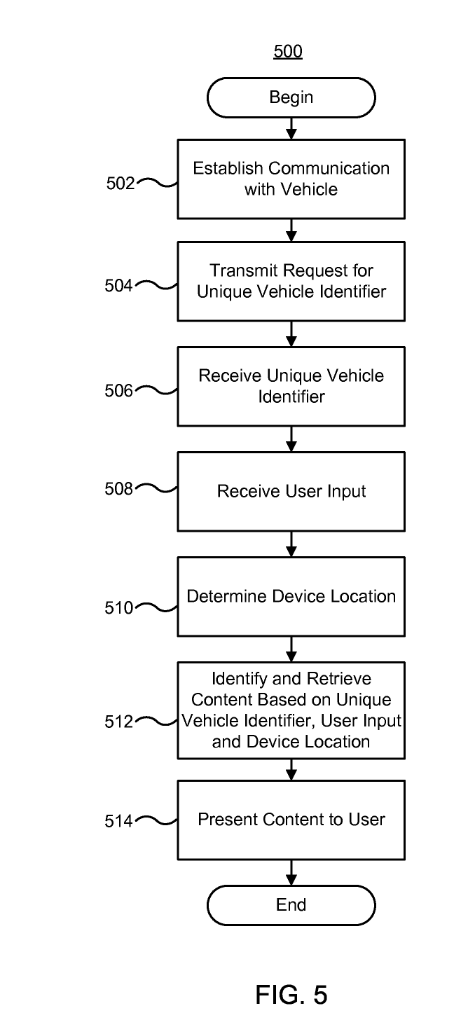

FIG. 5 is a flow diagram of a process usable by a portable electronic device (e.g., portable electronic device 102 of FIG. 1 or portable electronic device 202 of FIG. 2) to identify content based on a unique vehicle identifier, user input, and a geographic location of the device according to an embodiment of the present invention

At block 502, the portable electronic device can establish communication with the vehicle. For example, the portable electronic device can detect a connection to the vehicle based on a voltage detected at the connector. The vehicle may also request a connection via a wireless protocol (e.g., Bluetooth, WiFi, and/or the like), and the portable electronic device can respond to establish a connection usable to exchange messages.

Upon detecting a connection, the portable electronic device can communicate with the vehicle to perform a number of authentication steps by exchanging messages (e.g., utilizing vehicle interface 228 and device interface 236 of FIG. 2). For example, the vehicle can transmit one or more messages to the portable electronic device to identify and authenticate the vehicle, and/or the portable electronic device can transmit one or more messages to the vehicle to identify and authenticate the portable electronic device. Messages exchanged at block 502 can also relate to the respective capabilities of the vehicle and the portable electronic device. For example, the portable electronic device can transmit a message to the vehicle indicating that the portable electronic device is configured to accept and act on a received message containing a unique vehicle identifier. Similarly, the vehicle can transmit a message to the portable electronic device indicating that the vehicle is configured to generate and transmit a message containing the unique vehicle identifier. Communication between the portable electronic device and the vehicle can be established upon completion of the exchange of messages relating to the capabilities and authentication. In some embodiments, the portable electronic device can provide a user with a notification that communication with the vehicle is established by, for example, providing audio output at a speaker and/or visual output on a display screen of the portable electronic device.

At block 504, after communication between the portable electronic device and the vehicle is established, the portable electronic device can transmit a message to the vehicle, the message containing a request for a unique vehicle identifier. At block 506, the vehicle can generate and transmit a message to the portable electronic device, the message containing the requested unique vehicle identifier. For example, the message can contain a VIN for the vehicle, or one or more has values corresponding to the VIN.

At block 508, user input can be received at a user interface of the portable electronic device. For example, in an embodiment, the user interface can include an audio interface including a microphone, and the user can provide input to the portable electronic device in the form of audio input (e.g., spoken words or phrases). In some embodiments, the user interface can include a touch interface (e.g., a touch screen and/or control buttons), and the user can provide input to the portable electronic device in the form of touch input.

A geographic location of the portable electronic device can also be determined. For example, at block 510, the portable electronic device can utilize a GPS, cellular tower triangulation data, cellular tower signal strength data, wireless access point data, an Internet Protocol (IP) address, and/or any suitable technique for determining a geographic location of the portable electronic device.

Once the unique vehicle identifier and the user input are received, and the geographic location of the device is determined, at block 512, the portable electronic device can identify content based in part on the unique vehicle identifier, in part on the received user input, and in part on the determined geographic location. In some embodiments, the portable electronic device can use the unique vehicle identifier and/or the received user input to identify and retrieve content stored in a memory (e.g., storage device 222 of FIG. 2) of the portable electronic device. For example, the memory can store various specifications (e.g., replacement part identifiers, a user manual, year, make, model, color, etc.) for the vehicle as previously downloaded by the user from an Internet website associated with the vehicle's manufacturer and/or from any other suitable external data source. In some embodiments of the present invention, upon establishing communication with the vehicle, the portable electronic device can determine if such content has been downloaded and stored in the memory. If it is determined that the content is not present in the memory, the portable electronic device can prompt the user to perform the download. The stored content can be linked to the unique vehicle identifier, and in embodiments of the invention, the portable electronic device can store specifications for a plurality of the user's vehicles, each linked to the appropriate unique vehicle identifier.

In some embodiments of the present invention, at block 512, the portable electronic device can identify and retrieve the content from an external data source (e.g., external data source 110 of FIG. 1). For example, in lieu of or in addition to storing the content in a memory, the portable electronic device can retrieve the content from an external database associated with the vehicle manufacture (e.g., a website) or any other suitable external data source.

Further, at block 512, the portable electronic device can use the geographic location of the device to identify and retrieve content related to the location of the device. As an illustration, the user input can include a request for a replacement part identifier. At block 512, the portable electronic device can use the unique vehicle identifier to retrieve the replacement part identifier stored in the memory (e.g., as a digital version of the vehicles user manual) and/or stored externally and accessible via a data network, for example. Once the replacement part identifier is retrieved, the portable electronic device can prompt or “ask” the user via audio and/or visual output whether the user desires to know the location of a nearby merchant offering the replacement part for sale. Upon receiving confirmation from the user in the form of audio and/or touch input, the portable electronic device can identify and retrieve the requested merchant location. In some embodiments, the portable electronic device can automatically search for nearby merchants (i.e. without prompting the user). The portable electronic device can locate nearby merchants offering the replacement part for sale using any suitable technique. For example, the geographic location of the device and the replacement part identifier can be utilized as keywords in an Internet search (or other external database search) to locate the nearby merchants. In some embodiments, the portable electronic device can locate nearby merchants offering the replacement part for sale by accessing a register of merchants, merchant locations, and replacement part identifiers stored in the memory of the portable electronic device.

At block 514, the portable electronic device can present the identified content to the user via the user interface. For example, the portable electronic device can present visual output to the user via a display screen of the portable electronic device. As another example, the audio interface of the portable electronic device can include a speaker configured to present audio output to the user. As such, the portable electronic device can generate visual output and/or audio output based on the identified content, and can present the output to the user via the user interface. Referring back to the above illustration, once the replacement part identifier and the location of the merchant offering the replacement part for sale have been identified, the user can be provided with the identified content visually and/or audibly. For example, the portable electronic device can present the user with visual output on a display screen and/or audio output at a speaker indicating the replacement part identifier and the location of the merchant. In some embodiments of the present invention, the portable electronic device can provide the user with driving directions to the merchant by, for example, displaying a map on the display screen and/or by providing real-time driving directions as audio output at the speaker.

While the invention has been described with respect to specific embodiments, one skilled in the art will recognize that numerous modifications are possible and that features described with specific reference to one embodiment can be applied to other embodiments. For example, any combination of a unique vehicle identifier, user input, and geographic location can be utilized in various embodiments of the invention to identify content for presentment to a user. Moreover, such data can be received and processed in any suitable order.

In some embodiments, the portable electronic device can include a voice recognition mode (e.g., an “Intelligent Automated Assistant”). Such a voice recognition mode can include any operational mode of the portable electronic device wherein audio input (e.g., a word, phrase, or sound provide by a user), as distinguished from touch input (e.g., touch screen, button input, etc.), can be used to access various services, applications, and/or functionalities of the portable electronic device. For example, when a voice recognition mode is activated, the portable electronic device can process audio input received from the user at a microphone, generate audio and/or visual output based on the received audio input, and present the output to the user at a speaker and/or display screen of the portable electronic device. The voice recognition mode can be utilized in lieu of or in addition to the processing of touch input received from the user.

In some embodiments, upon transmitting the unique vehicle identifier to the portable electronic device, the vehicle can transmit messages containing further information. For example, messages can inform the portable electronic device of issues with the vehicle that may require user action (e.g., that the fuel is low, that the vehicle is due for a service or oil change, that the brake pads are worn, that the tire pressure is low, and the like). Upon receipt of such a message, the portable electronic device can inform the user of the issue audibly and/or visually, and can identify the appropriate replacement part identifier, a merchant offering the replacement part for sale, a nearby gas station, a nearby mechanic, and/or other content to the user. Periodic messages can also be transmitted by the vehicle to the portable electronic device, the messages containing information about the vehicle's fuel consumption, driving distance, and/or the like. As such, portable electronic device can visually and/or audibly present the user with information regarding miles per gallon and other driving statistics.

In some embodiments, the portable electronic device can run an application that may be provided, for example, by a vehicle manufacturer or a third party. The application may generate the message requesting the unique vehicle identifier from the vehicle. The application may also identify and retrieve the content based upon the unique vehicle identifier, and present the content to the user via a user interface of the portable electronic device. In some embodiments, the application may determine from messages received from the vehicle whether there are issues that require user action (as described above), and may inform the user of the issues audibly and/or visually. The application may also keep track of when previous services were performed, and timely inform the user when the vehicle is due for a service.

In some embodiments, the portable electronic device can utilize the unique vehicle identifier to identify and retrieve recall information for the vehicle. For example, the portable electronic device can periodically access an external database associated with the vehicle manufacturer (e.g., a website) or any other suitable external data source to determine whether a recall has been issued for the vehicle. The portable electronic device may further determine whether the recall is an urgent safety recall requiring immediate repair, or whether the recall need not be addressed immediately. Upon retrieval of such recall information, the portable electronic device can present the information to the user visually and/or audibly.

In some embodiments, the portable electronic device can be configured to generate and transmit messages to the vehicle, the messages causing the vehicle to change its operation. For example, if a vehicle is stolen after a connection has been established with a portable electronic device, the portable electronic device can send a message to the vehicle in response to user input, the message causing the engine power of the vehicle to be turned off. In some embodiments, the portable electronic device can be accessed remotely by another electronic device (e.g, a tablet computer, laptop computer, desktop computer, other portable electronic device, and/or the like). If the vehicle is stolen after a connection has been established (with the portable electronic device located inside the vehicle), the user can communicate with the portable electronic device using another electronic device to cause the portable electronic device to send a message to the vehicle, the message causing the engine power of the vehicle to be turned off.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A portable electronic device comprising:
a user interface;
a vehicle interface configured to exchange messages with a vehicle; and
a processor coupled to the user interface and the vehicle interface, the processor configured to:
receive a message from the vehicle interface, the message containing a unique vehicle identifier;
identify content based at least in part on the unique vehicle identifier; and
present the content to a user via the user interface.

2. The portable electronic device of claim 1, wherein the content includes a specification for the vehicle.

3. The portable electronic device of claim 2, wherein the specification includes one or more of: a fuel type for the vehicle, an oil type for the vehicle, an identifier of a replacement part for the vehicle, an identifier of a merchant offering the replacement part for sale, a user manual for the vehicle, a year of the vehicle, a make of the vehicle, a model of the vehicle, a color of the vehicle, or a year of manufacture of the vehicle.

4. The portable electronic device of claim 1, wherein the unique vehicle identifier comprises a vehicle identification number (VIN) or one or more hash values corresponding to the VIN.

5. The portable electronic device of claim 1, wherein the user interface is configured to receive input from the user, and wherein the processor is further configured to:
receive the input from the user interface; and
identify the content based in part on the input and in part on the unique vehicle identifier.

6. The portable electronic device of claim 1, wherein the processor is further configured to:
determine a geographic location of the portable electronic device; and
identify the content based in part on the geographic location and in part on the unique vehicle identifier.

7. The portable electronic device of claim 1, wherein the content identified by the processor is stored in a memory of the portable electronic device or stored external to the portable electronic device.

8. A portable electronic device comprising:
a user interface;
a vehicle interface configured to exchange messages with a vehicle; and
a processor coupled to the user interface and the vehicle interface, the processor configured to:
receive a message from the vehicle interface, the message containing a unique vehicle identifier;
receive user input from the user interface;
identify content based in part on the user input and in part on the unique vehicle identifier; and
present the content to the user via the user interface.

9. The portable electronic device of claim 8, wherein the user interface includes an audio interface, and wherein the user input includes audio input.

10. The portable electronic device of claim 8, wherein the user interface includes a touch interface, and wherein the user input includes touch input.

11. The portable electronic device of claim 8, wherein the user interface includes an audio interface configured to present the content to the user as audio output, and wherein the processor is further configured to:
generate the audio output based on the content; and
transmit the audio output to the audio interface.

12. A method for presenting vehicle-specific information to a user, the method comprising:
receiving, by a portable electronic device, a message transmitted from a vehicle, the message including a unique vehicle identifier;
identifying, by the portable electronic device, content based at least in part on the unique vehicle identifier; and
presenting, by the portable electronic device, the content to the user.

13. The method of claim 12, wherein the content includes a specification for the vehicle.

14. The method of claim 13, wherein the specification includes one or more of: a fuel type for the vehicle, an oil type for the vehicle, an identifier of a replacement part for the vehicle, an identifier of a merchant offering the replacement part for sale, a user manual for the vehicle, a year of the vehicle, a make of the vehicle, a model of the vehicle, a color of the vehicle, or a year of manufacture of the vehicle.

15. The method of claim 12, wherein the unique vehicle identifier comprises a vehicle identification number (VIN) or one or more hash values corresponding to the VIN.

16. The method of claim 12 further comprising:
receiving, by the portable electronic device, input from the user; and
identifying, by the portable electronic device, the content based in part on the input and in part on the unique vehicle identifier.

17. The method of claim 12 further comprising:
determining, by the portable electronic device, a geographic location of the portable electronic device; and
identifying, by the portable electronic device, the content based in part on the geographic location and in part on the unique vehicle identifier.

18. The method of claim 12, wherein the content identified by the portable electronic device is stored in a memory of the portable electronic device or stored external to the portable electronic device.

19. A method for presenting vehicle-specific information to a user, the method comprising:
receiving, by a portable electronic device, a message transmitted from a vehicle, the message including a unique vehicle identifier;
receiving, at a user interface of the portable electronic device, user input from the user;
identifying, by the portable electronic device, content based in part on the unique vehicle identifier and in part on the user input; and
presenting, by the portable electronic device, the content to the user.

20. The method of claim 19, wherein the user interface includes a display screen, and wherein presenting the content to the user comprises displaying visual output to the user on the display screen.

21. The method of claim 19, wherein the user interface includes a touch interface, and wherein the user input includes touch input.

22. The method of claim 19, wherein the user interface includes an audio interface, and wherein the user input includes audio input.

23. A computer-readable storage medium having program code stored thereon, the program code including instructions that, when executed by a processor in a portable electronic device, cause the processor to execute a method comprising:
receiving a message transmitted from a vehicle, the message including a unique vehicle identifier;
identifying content based at least in part on the unique vehicle identifier; and
presenting the content to a user.

24. The computer-readable storage medium of claim 23, wherein the content includes a specification for the vehicle.

25. The computer-readable storage medium of claim 23, wherein the specification includes one or more of: a fuel type for the vehicle, an oil type for the vehicle, an identifier of a replacement part for the vehicle, an identifier of a merchant offering the replacement part for sale, a user manual for the vehicle, a year of the vehicle, a make of the vehicle, a model of the vehicle, a color of the vehicle, or a year of manufacture of the vehicle.
